(19) United States
(12) Patent Application Publication
(10) Pub. No.: US 2014/0180996 A1
(43) Pub. Date: Jun. 26, 2014

(54) Computer Guided Model Checking System and Method

(71) Applicant: Solibri, Inc., Helsinki (FI)

(72) Inventors: Heikki Antero Kulusjarvi, Espoo (FI); Anupam Arohi, Espoo (FI); Pasi Tuomo Paasiala, Helsinki (FI)

(73) Assignee: Solibri, Inc., Helsinki (FI)

(21) Appl. No.: 14/105,299

(22) Filed: Dec. 13, 2013

Related U.S. Application Data
(60) Provisional application No. 61/736,888, filed on Dec. 13, 2012.

(51) Int. Cl. G06N 5/04

(52) U.S. Cl. CPC G06N 5/04
USPC 706/47

(57) ABSTRACT

A semi-automatic information filling system and method for a model checking system is disclosed. The information filling system and method identifies missing information in a computer-generated model that is a digital representation of a physical object. The information filling system and method is particularly useful in connection with a rules-based model checking system for a building information modeling (BIM) model.

### CROSS REFERENCE TO RELATED PATENT APPLICATIONS

This application claims priority from U.S. Provisional Patent Application No. 61/736,888, filed Dec. 13, 2012, which is hereby incorporated by reference.

### FIELD OF THE INVENTION

This invention relates to a semi-automatic information filling system and method for a rules-based model checking system. More particularly, the invention relates to a semi-automatic information filling system and method for a rules-based model checking system that identifies available and missing information in a computer-generated model and assists a user in supplying the missing information in the computer-generated model.

### BACKGROUND OF THE INVENTION

A computer-generated model of a physical object, such as building, is created to represent a digital version of the physical object. For a building, such a computer-generated model is referred to as a building information modeling (BIM) model. The BIM model represents the building including the components of the building and the structural and functional relationship between the components of the building. Once a computer has generated the BIM model, the completed BIM must be analyzed and validated, i.e. checked, for accuracy to be sure that the BIM model complies with building regulations and other building requirements specified by the rules set before construction is begun. For example, a school building located in a certain area of a city must comply with all the building regulations for schools in that area. Such building regulations constitute a portion of a rules set and may include, for example, minimum sizes for hallways, disabled access to certain areas, minimum height of ceilings, columns should touch the ceilings and the ground, walls should have openings for windows, doors should open in the correct direction, etc. The comprehensive rules set also includes other requirements and specifications for the proper construction of the building.

Typically, the BIM model is manually checked against the rules set for the particular building. In addition to the inherent problems with manual checking related to human error, the BIM model may be incomplete. For example, the rules set may require that all doors open inwardly. If, however, the BIM model does not include the classification for the component “doors,” the user checking the BIM model must first recognize the missing classification and then characterize all the components that are doors as “doors”. If the user is not informed to fill in this categorization information for a component, the quality of analysis is compromised. Prior BIM model validation and analysis systems lack the ability to determine if relevant information for the analysis is missing from the BIM model.

A BIM model matures as it passes various phases of development. At some point during development, the BIM model is checked with a rules-based model checking system in order to maintain quality. When the quality analysis is performed, the quality analysis is based on available information in the BIM model. The user performing the quality analysis could easily add even more pertinent information to the BIM model and hence could make analysis by the rule-based model checking system more comprehensive and meaningful. At present, adding additional pertinent information is accomplished through iteration. The user adds missing information during iterations of the analysis. Often, this information is already known to the user, so there is nothing to keep the user from adding the missing information. However, a user has an arduous task to identify all of information that would be required in order to complete a certain quality check or analysis by the rule-based model checking system.

FIG. 1 shows an example of how a conventional analysis by a rule-based model checking system is currently done and how a stakeholder/user 14 uses the conventional quality model checking method 1 in iterations. For example, at step 2, the user 14 initiates a minimum distance check between adjacent doors and columns by specifying a minimum distance rule for the model checking method 1. From step 2, the method 1 proceeds to step 3 where the method 1 collects all components classified as doors from the BIM model. Likewise, at step 4, the method 1 collects all components classified as columns from the BIM model. Having collected all of the components classified as doors and columns at steps 3 and 4 respectively, the method 1 moves to step 5 where the method 1 computes the distances between all adjacent doors and columns. From step 5, the method 1 moves to step 6 where the method 1 marks all doors and columns with a distance greater than the specified 1 m rule red and marks all doors and columns with a distance of less than 1 m green. Upon reviewing the results, the user realizes that many doors and columns are neither marked green nor red. The user then must manually classify those missed doors and columns at step 7 and perform the whole analysis process again.

FIG. 2 is a screenshot illustrating how a component, such as a column, is characterized in terms of the component's attributes in a model checking system. For example in FIG. 2, the column has the attribute of a profile type 20 (“circular”) and the attribute of a name 22 (“column 36”). Each component has attributes that could help determine its classification. However, the final classification decision is still made manually by the user. The invention uses this attribute information to resolve arduous iterative process of classifying.

### SUMMARY OF THE INVENTION

The present invention solves the challenge of determining all of the information that is required for a certain quality check and of creating an appropriate task list to make sure that the user can add that information and keep track of what has been added. The invention integrates with existing model checking software and becomes an integrated part of the quality checking process. The present invention makes adding missing information to the BIM model easier for the user.

The model checking system and method for checking a computer-generated model of a physical object, including checking the BIM model of a building, in accordance with the present invention, compares a pre-established rules set to the BIM model in order to determine if the BIM model is missing relevant information required by the rules set and ultimately if the BIM model complies with building regulations and other requirements for the proper construction of the building represented by the BIM model.

The model checking system and method of the present invention, including an information filling system and method, begins by determining what building component information is required in the BIM model by parsing the pre-established rules set for the building and thereby extracting the requirements for the resulting building. Building component information for the building includes not only information about individual building components, but also the functional and physical relationship between components of the building. Once the requirements for the building have been extracted from the rules set, the information filling system and method of the model checking system and method compares the requirements of the rules set to the BIM model to determine if any building component information is missing. If the model checking system and method identifies missing information, the model checking system and method generates a list of tasks relating to any missing building component information so that the user can add such missing information to the BIM model. As the user performs each of the tasks identified by the information filling system and method of the model checking system and method, the model checking system and method keeps track of the valid completion of each task. Once the user has completed all of the updating tasks identified by the model checking system and method, the model checking system and method performs a final application of the rules set to the updated BIM model to confirm compliance of the BIM model with the rules set for the building

The model checking system and method, with the information filling system and method of the present invention, differs from BIM model checking systems that currently exists because such existing BIM model checking systems do not check for required and missing information before initiating the model analysis. Further, the currently existing BIM model checking systems do not have a way of easily updating the BIM model with any missing component information. Consequently, the failure of the existing BIM model checking systems to account for missing information in the BIM model compromises the quality of the final validation and analysis results.

Further objects, features and advantages will become apparent upon consideration of the following detailed description of the invention when taken in conjunction with the drawings and the appended claims.

### BRIEF DESCRIPTION OF THE DRAWINGS

FIG. 1 is a block diagram of a computer-generated model checking system in accordance with the prior art.

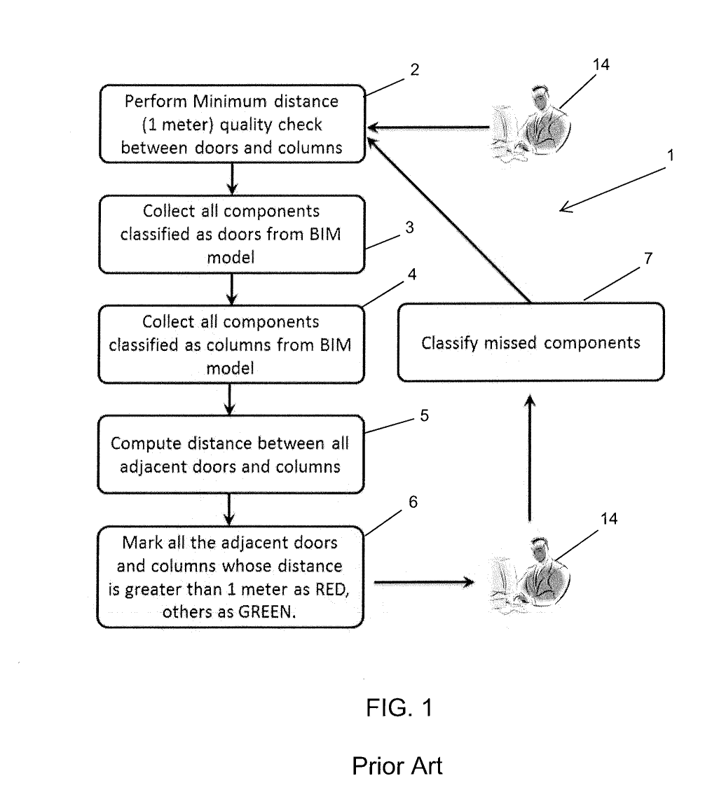

FIG. 2 is a screenshot for a computer-generated model checking system in accordance with prior art.

FIG. 3 is a block diagram of a computer-generated model checking system in accordance with the present invention.

FIG. 4 is a flowchart of a computer-generated model checking method in accordance with the present invention.

FIG. 5 is a flow chart showing an example how the invention alleviates the iterative process and gives user a to-do list in accordance with the present invention.

FIG. 6 is a screenshot of a sample to-do list generated in accordance with the invention.

FIG. 7 is a screenshot depicting how a model checking rule could be designed and parameterized in accordance with the present invention.

FIG. 8 shows a screenshot of a complex rule, its various parameters, and sample values in accordance with the present invention.

FIG. 9 shows a screenshot where the invention proposes certain tasks for a certain model checking rule in accordance with the present invention.

FIG. 10 is a screenshot of a to-do list that shows how the items on the to-do list are crossed out after relevant step has been performed in accordance with the present invention.

FIG. 11 depicts the flowchart of a prospective analysis process in accordance with the present invention.

### DETAILED DESCRIPTION OF THE PREFERRED EMBODIMENT

### TERMS AND DEFINITIONS

### Stakeholder

Stakeholder is a person who plays a role in the design and development of a facility. The stakeholder can represent the owner of the facility, an architect, mechanical engineer, electrical engineer, construction manager, civil engineer, interior designer, contractor, and the like. A stakeholder is a likely user of the present invention.

### BIM Model

A Building Information Modeling (BIM) model is a digital representation of the physical and functional characteristics of a facility. A BIM model is a shared knowledge resource for information about a facility forming a reliable basis for decisions during the BIM model's life cycle, defined as existing from earliest conception to demolition.

### Issue

An issue is a defect that may lead to misconstruction or a situation where the actual construction may not be feasible. Examples of issues are: clashes (components interfering with other components); overlap (same kind of components e.g. wall overlapping each other in the model); number of components “missing” from the model. Further examples include load bearing structures need components on the bottom (components are not hanging in the air) and loadbearing structures need to support some component on top; components of certain type having different dimensions; number of code violence according to a specific building code; etc.

### Rule

A rule defines a single unit of analysis for a quality check. For example, for a building, it is essential that all vertical components viz. walls, doors, etc. touch the floor. To check that all vertical components touch their respective floors, a rule is developed. This rule would require components that are classified as vertical components have a relationship with the floors, i.e. those components that are classified as floors. When this rule is executed by model checking software, the distances between all available vertical components and their respective floors are measured. If the distance is more than zero, those distances are flagged as error. A rule could also be a simple check that all floors have a numeric suffix and that suffix is consecutive for consecutive floors. Further, a rule could have parameters and could be associated with tasks. For example, a minimum distance rule could state that there should be a minimum distance of X meters between columns and walls. For this rule, X could be set to 2 meters, and a classification tasks could be created to classify walls and columns.

### Rule Set

A rule set is a set of commonly related rules. For example, an accessibility rule set would include accessible door rule, accessible ramp rule, accessible stair rule, accessible window rule and free floor space rule.

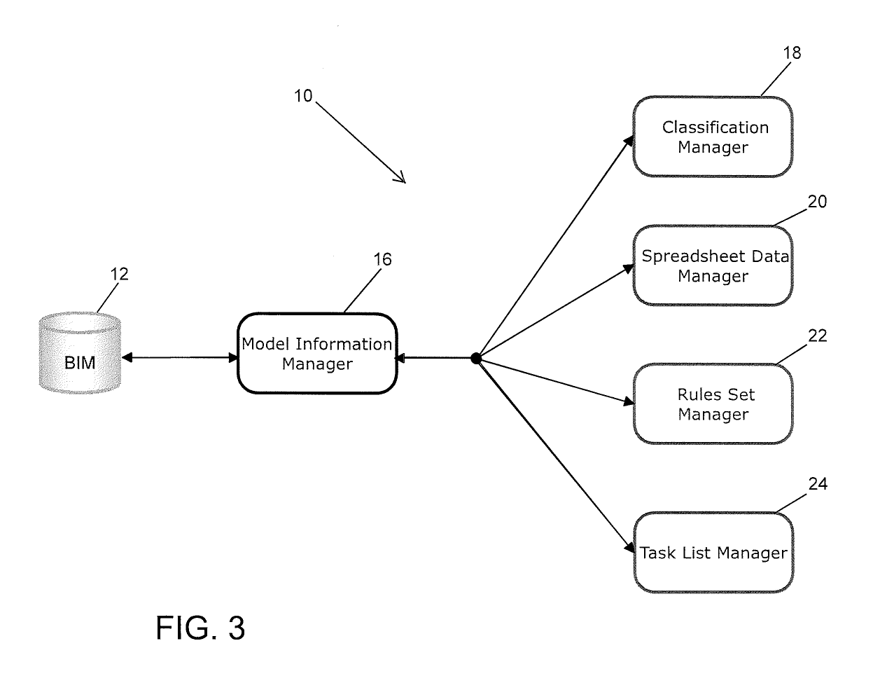

Turning to FIG. 3, a model checking system 10, including an information filling system, allows a user of the model checking system 10 to identify component information missing from a computer-generated model of a physical object. In the case of a building, the model checking system 10 identifies missing building component information in a computer-generated building information modeling (BIM) model 12. The BIM model 12 is well known in the art and digitally represents the building components and the structural and functional characteristics of a building.

Software modules running on a general-purpose digital computer implement the model checking system 10 including the information filling system. Particularly, the model checking system 10 includes a model information manager module 16, a classification manager module 18, a spreadsheet data manager module 20, a rules set manager module 22, and a task list manager module 24. The model information manager module 16 extracts a set of rules from the rules set manager module 22 in order to identify information that is missing from the BIM model 12.

The rules set manager module 22 contains pre-established sets of rules, including building regulations and other building specifications for particular buildings. For example, the rules set manager module 22 may contain a rules set for school buildings in a particular area, another rules set for office buildings in a particular area, and yet another rules set for residential buildings in another area. Each rules set represents regulations and specifications for what is required in a particular building and therefore establishes a baseline for determining what information must be included in the BIM model.

The model information manager module 16 analyzes and as necessary modifies the BIM model 12. The model information manager module 16 receives the rules set for the particular building represented by the BIM model 12. The model information manager module 16, including the information filling system, compares the rules set information to the BIM model 12 in order to identify any building component information missing from the BIM model 12. If the model information manager module 16 identifies missing information from the BIM model 12, the model information manager module 16 instructs the task list manager 24 to generate and display a task list identifying the missing information for a user of the model checking system 10. The task list gives the user of the model checking system 10 the ability to update the BIM model 12.

If, for example, the model information manager module 16 identifies that the classification “doors” is missing from the BIM model 12, the user may call on the classification manager module 18 to assist in supplying the missing building component classifications to the BIM model 12 via the model information manager module 16. Particularly, the classification manager module 18 establishes classifications for the building components. For example, the component classifications may include classifications for “doors” as a class of components, “walls” as a class of components, “windows” as a class of components, etc. Such classification facilitates updating the components of the BIM model by the user via the model information manager 16.

If, for example, the model information manager module 16 identifies that the specification for a particular component of the building is missing from the BIM model 12, the user may call on spreadsheet data manager module 20 to assist in supplying the missing specification for the particular building component to the BIM model 12 via the model information manager module 16.

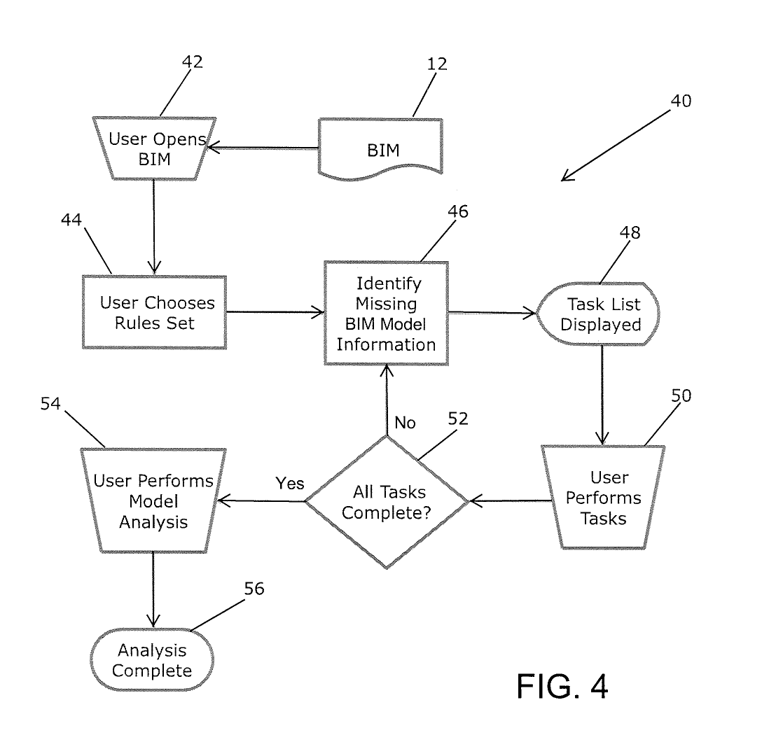

FIG. 4 illustrates a model checking method 40 that is implemented by the model checking system 10 of FIG. 3. The model checking method 40, including an information filling method begins with the BIM model 12. At step 42 of the model checking method 40, the user opens the BIM model 12 by means of the model information manager 16. From step 42, the method proceeds to step 44 where the user selects a pre-established rules set from a plurality of pre-established rule sets available from the rule set manager module 22. The selected rules set is a particular pre-established and comprehensive set of rules for the particular building represented by the BIM model 12. For example, if the building represented by the BIM model 12 is a school building in a particular city, the user selects the pre-established rules set that is specific to that particular building. The selected rules set is comprehensive and includes the building regulations and building specifications for the particular building.

Once the BIM model 12 has been opened by the model information manager module 16 and the particular pre-established rules set has been selected by the user from the rules set manager module 22, the model checking method 40 proceeds to step 46. At step 46, the model information manager module 16 compares the selected rules set to the BIM model 12 to check for missing component information. For example, the selected rules set may require that all doors for the building opened inwardly. If, for example, “doors” is not a classification for components in the BIM model 12, the model information manager module 16 at step 46 identifies the classification of “doors” as missing information. Similarly, the selected rules set may require that hallways in the building be of a certain width.

Once the model information manager module 16 has identified missing component information in the BIM model 12 at step 46, the model checking method 40 moves to step 48, where the model information manager 16 communicates the missing component information to the task list manager module 24. At step 48, the task list manager module 24 then compiles and displays a list of tasks that require the user to supply missing component information to the BIM model 12. For example, a listed task might require the user to classify components in the BIM model 12 as “doors,” which components were not previously classified in the BIM model 12, or a listed task might require the user to supply specification for a particular building component.

From step 48, the model checking method 40 proceeds to step 50. At the step 50, the user performs each of the tasks listed and displayed by the task list manager module 24. If one of the tasks requires the user to classifying components in the BIM model 12, the user may call on the classification manager module 18 to assist in classifying components in the BIM model 12. Likewise, if one of the tasks requires the user to specify a building component, the user may call on the spreadsheet data manager module 20 to assist in providing the missing specification data for the particular building component.

As the user completes each task, the model checking method 40 moves to step 52, where the model information manager module 16 determines if the user has completed all of the tasks. If all of the tasks listed by the task list manager module 24 have not been completed, the model checking method 40 returns to step 46 where the model information manager module 16 again compares the rules set from the rules set manager module 22 to the BIM model 12 to check for missing component information. If the user has not correctly performed one of the tasks from the task list, the check by the model information manager module 16 at step 46 will not only find the original missing information relating to the listed tasks, but will also identify the circumstance that the user has incorrectly performed one of the listed tasks by failing to supply the necessary missing information. If on the other hand, the model information manager module 16 determines at step 52 that all tasks have been successfully completed, the model checking method 40 proceeds to step 54 where the user initiates an analysis of the BIM model 12 to check if the BIM model 12 is in conformity with the selected rules set and that the BIM model 12 is ready for the next development phase. From step 54, the model checking method 40 proceeds to step 56 where the model checking method ends.

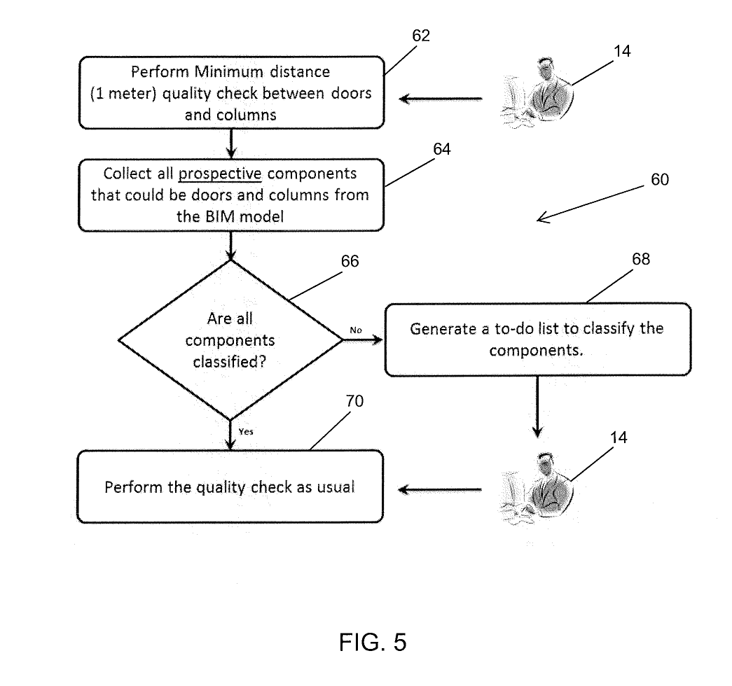

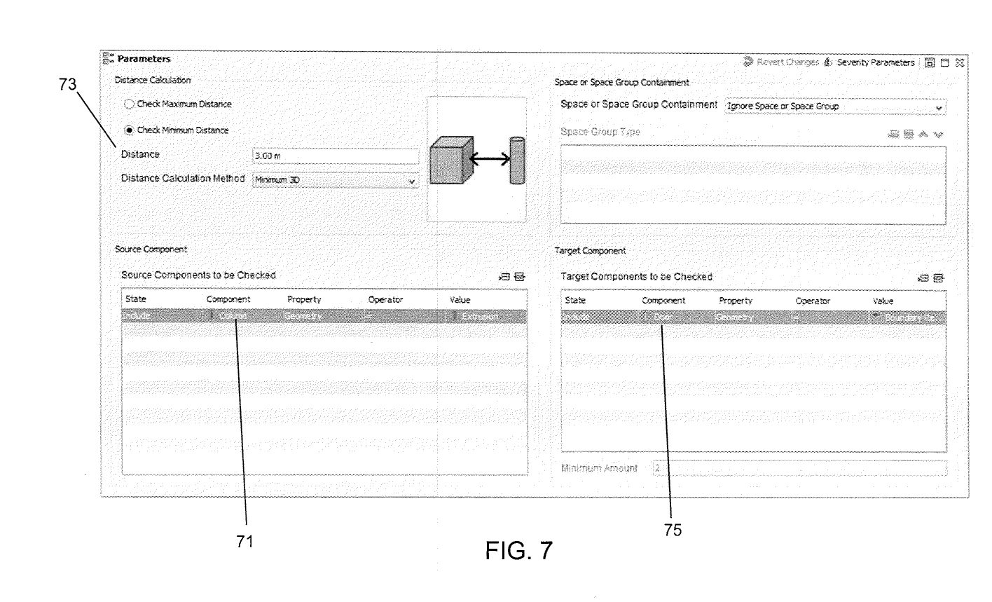

FIG. 5 shows a model checking method 60, which is a specific example of the generalized model checking method 40 of FIG. 4. The model checking method 60, including an information filling method of the present invention, checks for all the prospective unclassified door and column components and prepares a to-do list for the user to classify all of the door and column components. Particularly, in FIG. 5 the model checking method 60 illustrates the application of a particular rule, such as checking the minimum distance between doors and columns (3 meters), in the BIM model 12. The illustrative model checking method to 60 commences at step 62 where the user 14 opens the BIM model 12 and specifies, for example, a rule for the minimum distance between doors and columns. If a column is too close to a door, the door is unusable. FIG. 7 illustrates the creation of a particular minimum distance rule, such as a requirement for the minimum distance between doors and columns. In creating the minimum distance rule, the user 14 specifies that the components to be checked are columns 71 (“source components to be checked” in FIG. 7) and doors 75 (“target components to be checked” in FIG. 7). In addition, the user 14 specifies the minimum distance 73 (distance equals 3.00 m in FIG. 7) between the door and column components. The rule illustrated by FIG. 7 is used in connection with the generalized model checking method 40 and the more specific model checking method 60 for checking the minimum distance between doors and columns.

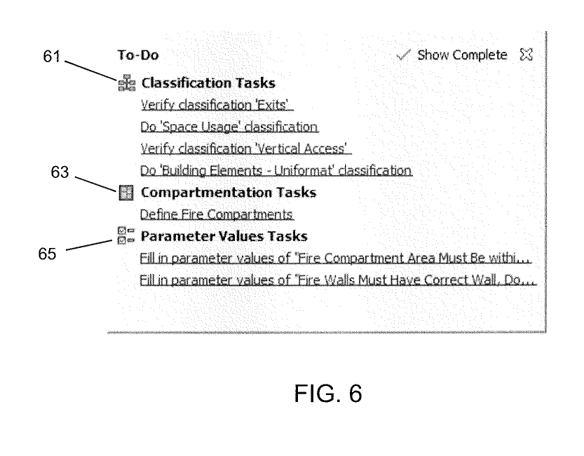

Once the user 14 has specified the minimum distance rule between doors and columns at step 62, the method 60 then proceeds from step 62 to step 64 where the method 60 collects all prospective components that could be doors or columns from the BIM model. Once the method 60 has collected all of prospective door and column components, the method 60 proceeds to step 66. At step 66, the method 60 determines if the collected components have been classified as doors or columns. If at step 66, the method 60 determines that all of the prospective door and column components have been classified, the method 60 follows the “Yes” branch to step 70 where the model checking method 60 performs the usual quality check based on the minimum distance rule specified in step 62. If, on the other hand, some of the collected components have not been classified, the method 60 follows the “No” branch, and all of the unclassified components are added to a to-do list at step 68. From step 68, the user 14 classifies each of the components listed on the to-do list presented at step 68. Once the user 14 has completed the classification of all the door and column components listed on the to-do list 68, the user 14 then initiates the usual quality check based on the minimum distance rule specified in step 62. In this way, user 14 does not need to manually check for missing components after performing the quality check at step 70. All the prospective components are already covered by the to-do list at step 68. The to-do list is not limited to only classification tasks, the to-do list may also include tasks like defining compartments, providing parameter values etc. FIG. 6 shows a sample to-do list generated at step 68 of a more complex example including the requirement for performance of classification tasks 61, compartmentation tasks 63, and parameter value assignment tasks 65.

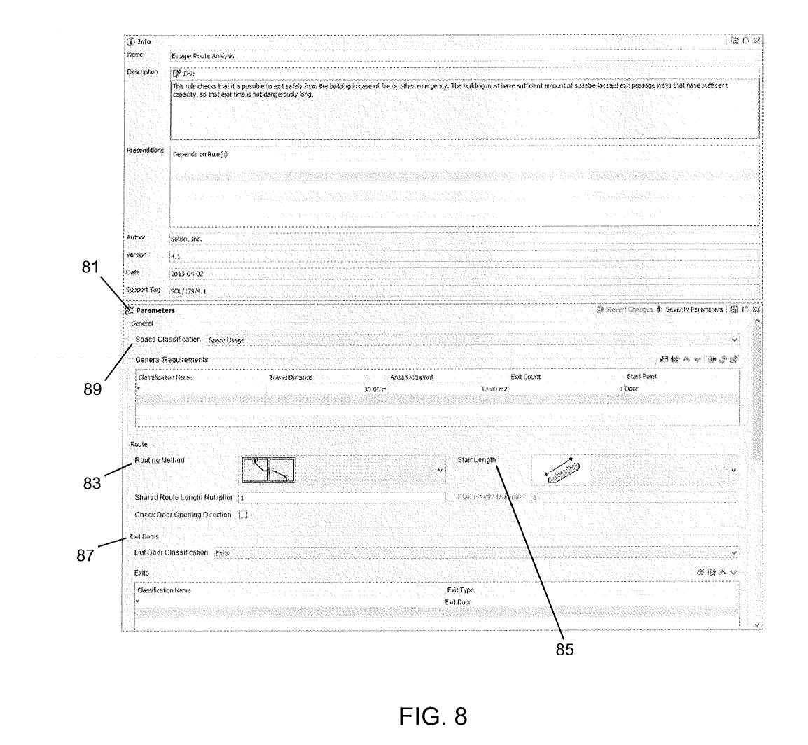

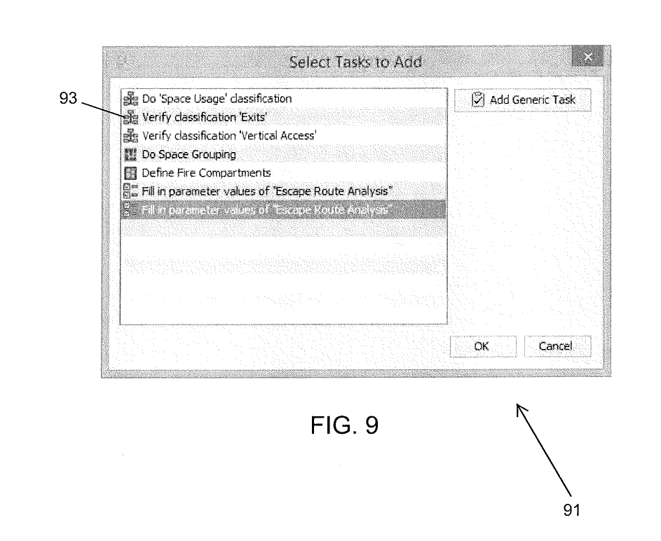

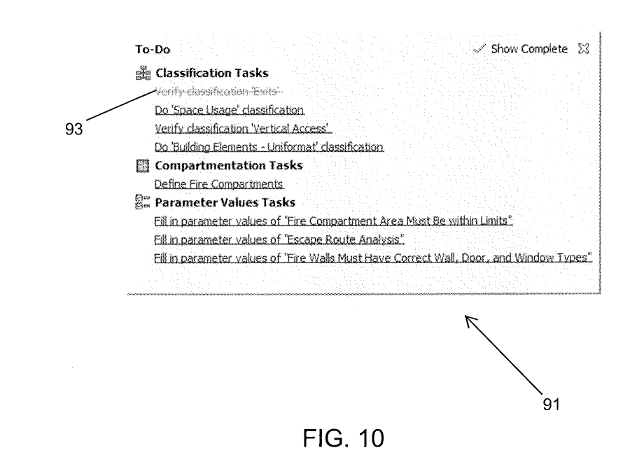

When the user 14 designs a rule, the user 14 knows the prerequisites to operate the rule. For the simple doors and columns minimum distance example above, all doors and columns must be classified, and the minimum distance is specified as depicted in FIG. 7. For a more complex example, such as assuring the existence of an escape route from a building in case of fire, more prerequisites are required as shown in FIGS. 8, 9, and 10. FIG. 8 illustrates an escape route rule for checking the BIM model 12. Particularly, the user 14 specifies the parameters 81 required for the escape route rule. The parameters 81 include specifying the route 83, specifying the stair length 85, specifying the exit door classification 87, and specifying the space classification 89. These parameters are then saved in the escape route rule of FIG. 8. When the user 14 executes the escape route rule, the system 10 checks if these conditions are met before performing the analysis in step 54 (FIG. 4). These conditions also become part of a to-do list 91 (FIG. 9). As the user 14 performs each task on the to-do list 91, like the “verify classification exits” task 93, the task is automatically shown as completed on the to-do list 91 as shown in FIG. 10.

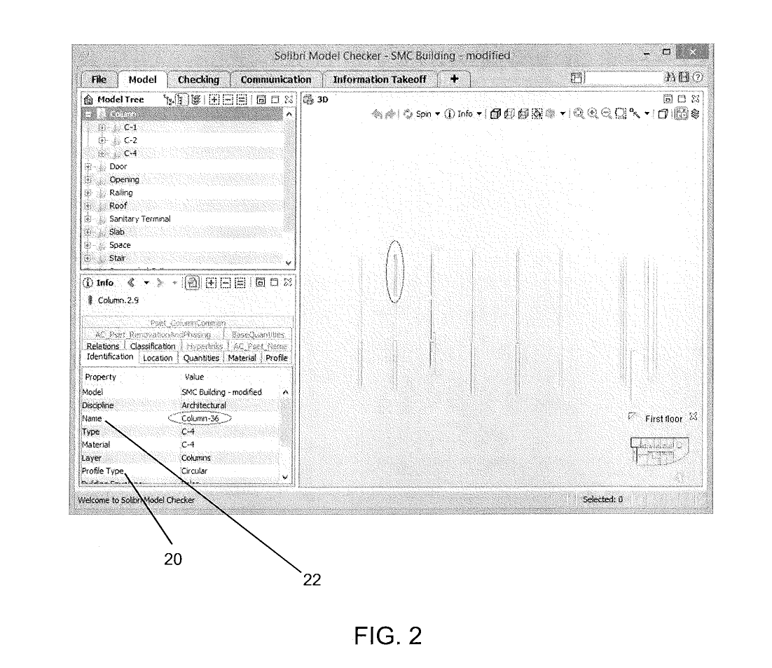

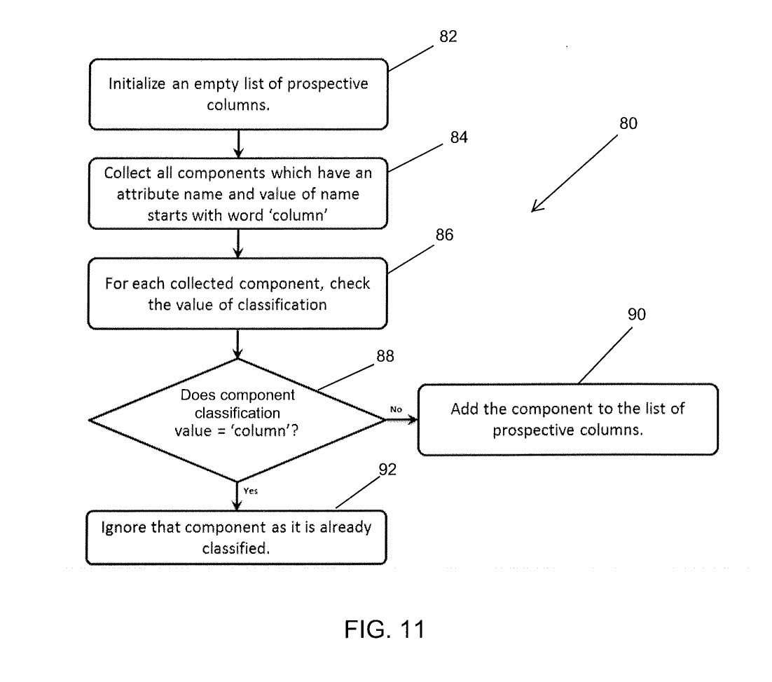

The method 40 and the method 60 perform a “prospective analysis” to assist the user in classifying components on a component by component basis rather than requiring the user to see all of the components and classify the components as they appear in the BIM model 12. As shown in FIG. 2, all columns, for example, have an attribute name that starts with a word “column”. This attribute is used to identify the component as a prospective candidate for classification. The method 40 and method 60 are able to identify whether component information, such as classification information, is missing from the BIM model 12. Particularly, step 46 of FIG. 4 and step 64 of FIG. 5 are implemented by a find missing information method 80 illustrated in FIG. 11. The find missing information method 80 is illustrated with respect to finding components, such as columns, with missing classification information. The method 80 begins at step 82 with an initialized empty list of prospective columns. The method 80 then proceeds to step 84 where the method 80 collects all components that have the attribute name and the value of the attribute name starting with the word “column.” The result of step 80 is to compile a comprehensive list of all components that can be prospectively classified as columns. From step 84, the method 80 proceeds to step 86 where the method 80 checks each of the collected components for the value of the attribute name. From step 86, the method 80 proceeds to step 88. At step 88, the method 80 determines if the component's attribute name value equals “column.” If the component's attribute name value equals “column” at step 88, the method 80 proceeds along the “Yes” branch to step 92 where the method 80 ignores that particular component because that component is already classified. If, on the other hand, at step 88, the component's attribute name value does not equal “column,” the method 80 proceeds along the “No” branch to step 90. At step 90, the component is added to a list of prospective columns for classification by the user. That way, two major purposes are solved, viz. user 14 is asked to provide prerequisite information before doing the analysis (step 54, FIG. 4 and step 70, FIG. 5), and user 14 is presented with a prospective list to provide that missing information.

While the model checking system and method have been described above in connection with the BIM model 12, the invention data is not limited to BIM models. The model checking system and method of the present invention lends itself to such computer-generated models, including, without limitation, automotive design, airplane design, engine design, plant design and many other disciplines where computer-generated models must be checked and analyzed before physical products are built.

While this invention has been described with reference to preferred embodiments thereof, it is to be understood that variations and modifications can be affected within the spirit and scope of the invention as described herein and as described in the appended claims.

I claim:

1. A model checking system for checking a computer-generated model representing a physical object comprising:
a. a rules set manager module containing a pre-established rules set that specifies requirements for the physical object;
b. a model information manager module that compares the rules set to the computer-generated model and identifies information missing from the computer-generated model;
c. a task list manager module for receiving the identify missing information from the model information manager module and creating a task list listing the missing information from the computer-generated model.

2. The model checking system of claim 1, wherein the model information manager further determines whether missing information on the task list has been supplied to the computer-generated model and then analyzes the computer-generated model for conformance with the rules set.

3. The model checking system of claim 1, wherein the model checking system further comprises a classification manager module that classifies components of the physical object and provides classification information to a user of the model information manager module in order to assist the user in supplying missing information to the computer-generated model.

4. The model checking system of claim 1, wherein the model checking system further comprises a spreadsheet data manager module that includes additional information about the physical object and supplies that additional information to a user of the model information manager module in order to assist the user in supplying missing information to the computer-generated model.

5. A model checking method for checking a computer-generated model representing a physical object, the method comprising the steps of:
a. providing the computer-generated model;
b. selecting a pre-established rules set that specifies requirements for the physical object;
c. comparing the rules set to the computer-generated model to identify information missing from the computer-generated model; and
d. generating a task list listing the information missing from the computer-generated model.

6. The model checking method of claim 5, wherein the model checking method further comprises the step of determining whether the missing information identified by the task list has been supplied to the computer-generated model.

7. The model checking method of claim 6, wherein if the missing information identified by the task list has been supplied to the computer-generated model, the model checking method further compares the selected rules set to the computer-generated model in order to identify any discrepancies between the selected rules set and the computer-generated model.

8. The model checking method of claim 5, wherein the model checking method further comprises providing the missing information identified by the task list from a spreadsheet listing of attributes of the physical object.

9. The model checking method of claim 5, wherein the model checking method further comprises providing the missing information identified by the task list from a classification manager listing classifications for attributes of the physical object.
